(19) United States
(12) Patent Application Publication
(10) Pub. No.: US 2001/0024457 A1
(43) Pub. Date: Sep. 27, 2001

(54) Encoding signaling information at a physical layer of a network protocol

(76) Inventors: Richard A. Barry, Brookline, MA (US); Murat Azizoglu, Concord, MA (US)

Correspondence Address: Daniel P. McLoughlin, c/o Wolf, Greenfield & Sacks, P.C., 600 Atlantic Avenue, Boston, MA, 02210, US

(21) Appl. No.: 09/759,719

(22) Filed: Jan. 12, 2001

Related U.S. Application Data
(60) Provisional application No. 60/176,669, filed on Jan. 18, 2000.

(51) Int. Cl. H04J 3/16

(52) U.S. Cl. 370/537; 370/466

(57) ABSTRACT

A method and system for encoding signaling information at a physical layer of a network protocol, for example, an Ethernet-based protocol such as Gigabit Ethernet (GE). On a first network device, the signaling information may be encoded and multiplexed with data encoded according to a first block coding scheme to produce a stream of data encoded according to the first block coding scheme. The signaling information may be encoded using bit sequences not defined for use by the block first block coding scheme. This stream of data then may be transmitted on a network medium to another network device, which then may extract the bit sequences encoding the signaling information from the stream of data and decode the bit sequences into the signaling information. For two devices exchanging data on a first channel, signaling information may be multiplexed within this first channel itself, rather than sent on a separate channel. Further, to exchange signaling information, the two devices do not have to implement a protocol or part of a protocol at a layer higher than the physical layer. As a result, the configuration of these two devices is simplified.

### RELATED APPLICATIONS

This application claims priority under 35 U.S.C. §119(e) to commonly-owned, co-pending U.S. provisional patent application Ser. No. 60/176,669, entitled, “GE SIGNALING ARCHITECTURES FOR INTELLIGENT OPTICAL NETWORKS” filed on Jan. 18, 2000, which is hereby incorporated by reference in its entirety.

Further, this application is related to commonly-owned U.S. patent applications: “SERVICE DISCOVERY USING A USER DEVICE INTERFACE TO AN OPTICAL TRANSPORT NETWORK” by John T. Moy et al., “SIGNALING USING A USER DEVICE INTERFACE TO AN OPTICAL TRANSPORT NETWORK,” by John T. Moy et al., and “CREATING AN OPTICAL TRAIL ACROSS AN OPTICAL TRANSPORT NETWORK IN RESPONSE TO NETWORK TRAFFIC BETWEEN NETWORK DEVICES EXTERNAL TO THE OPTICAL TRANSPORT NETWORK,” by John T. Moy et al., each of which was filed on even date herewith and is hereby incorporated by reference in its entirety.

### BACKGROUND

There are several protocols in use today that enable communication between two or more devices on a network, for example, by defining procedures, data elements, and objects to be used to communicate between the devices. Such a protocol for communicating on a network is referred to herein as a “network protocol” and such a device on a network is referred to herein as a network device.

A network protocol may define a protocol specific to a Local Area Network (LAN), a Metropolitan Area Network (MAN), a Wide-Area Network (WAN), or a combination thereof. Further, a network protocol may define a protocol specific to one or more layers of the Open System Interconnection (OSI) network layering model promulgated by the International Organization for Standardization. For example, some protocols, such as the Transport Control Protocol (TCP)/Internet Protocol (IP) suite of protocols and the Point-to-Point Protocol (PPP), are specific to higher layers of the OSI network model, such as the Network, Transport and Session layers of the OSI network model. Other protocols, for example, Synchronous Optical Network (SONET) and Ethernet-based protocols such as Ethernet, Fast Ethernet and Gigabit Ethernet (GE), are specific to lower layers of the OSI network model, including the Physical Layer.

GE is a LAN protocol for communicating information between network devices. Ethernet-based protocols have been standardized by IEEE Standard 802.3, which is constantly evolving to incorporate emerging technologies. Accordingly, the IEEE 802.3z specification (i.e., hereinafter the GE specification) defines a standard for GE. GE and the GE specification are described in more detail in Gigabit Ethernet, Protocol Applications for High-Speed LANs, by Rich Seifert (hereinafter the Seifert reference), published by Addison-Wellesley, 1998. The GE specification and the Seifert reference are hereby incorporated by reference in their entireties.

Several network protocols define block coding schemes for encoding data to be exchanged between network devices. Typically, these encoding schemes are performed at the physical layer of the network protocol. As used herein, a “block coding scheme” is a scheme for encoding one or more data bits as one or more code bits referred to herein as a code word. Typically, a code word includes more bits than the data bits that it encodes.

There are several block coding schemes, including 4B/5B used by the Fast Ethernet as defined by IEEE 802.3u (hereinafter the Fast Ethernet specification) and 64B/66B used by the 10 GE LAN protocol currently being developed by the IEEE P802.3ae Ethernet Task Force.

The GE specification defines an 8B/10B block coding scheme to be applied at the physical layer of a network protocol. In the 8B/10B encoding as defined by the GE specification, eight data bits are encoded as ten output bits by a known and invertible function. Specifically, if x represents a sequence of eight input bits, then a function y=h(x) may be applied (e.g., by an encoder) to x to produce y, where y is the ten output bits, and where h(x) is fully invertible (i.e., for the function h(x), a function do may be applied (e.g., by a decoder ) such that d(h(x))=x).

The 8B/10B code words defined by GE are specified to balance the number of ones and zeros in a data stream and to provide a sufficient transition density for clock recovery, as described in more detail in the Seifert reference. As defined by GE, of the possible 1024 (2¹⁰) 10-bit sequences, at most 512 of these sequences (and actually less due to the details of 8B/10B encoding) are used to encode 8-bit input data sequences. Each of the 8B/10B code words (and the K-characters described below) defined by GE have a Hamming weight value (i.e., a number of binary 1s in a 10-bit code word) equal to 4, 5 or 6.

Of the remaining at least 512 10-bit sequences, GE specifies that 24 of these 10-bit sequences are used for GE internal control words which are referred to as K-characters. Accordingly, there are at least 488 remaining 10-bit sequences that are not defined for use by the GE protocol.

The GE specification defines a protocol corresponding to the Physical Layer and the Data Link Layer and of the Open System Interconnection (OSI) layering model. Specifically, the GE specification defines a GE Media Access Control (MAC) layer, which corresponds to a sub-layer of the Data Link Layer of OSI, and a GE physical layer, which corresponds to the OSI Physical Layer. The Seifert reference, specifically chapter 9, provides a more detailed description of the relation of GE to OSI layering.

The functionality specified by the GE MAC layer and higher-layer protocols such as the Session, Transport and Network Layers specified by OSI, may include, among other functions, delineating a GE packet, checking the source and destination address of a packet, verifying the integrity of a packet using the Frame Check Sequences (FCS) of the packet header, discarding corrupt packets, and invoking flow control if necessary.

The functionality specified by the lower GE physical layer includes encoding data bits as code words (e.g., in accordance with a block coding scheme), converting code words into a serial stream of electrical or optical signals, transmitting such signals onto a network medium, receiving such signals from a network medium, converting such signals into code words, and decoding code words into data bits (e.g., in accordance with a block coding scheme).

Some lower-layer network protocols, for example, SONET, provide a mechanism for exchanging signaling information between network devices. SONET provides Data Communication Channel (DCC) overhead bytes that can be used to exchange signaling information between network devices.

As used herein, “signaling information” is one or more signaling messages, where a signaling message is a message exchanged between two network devices for controlling a channel on which data is being exchanged between the two network devices. For example, for a client/server application, a channel may be established between a network device on which the server side of the application resides and a network device on which the client side of the application resides. A signaling message corresponding to the channel may be, among other messages, a message to create the channel, a message to destroy the channel, a message to change one or more parameters of the channel, or a message responding to one of these messages.

Other lower-layer network protocols, for example, GE, do not provide a mechanism for exchanging signaling information between network devices. In other words, such protocols do not reserve any bytes to exchange signaling information.

Typically, for lower-layer network protocols that do not provide a mechanism for exchanging signaling information, higher-layer protocols, for example, network, transport and session layer protocols, are used to exchange the signaling information between two network devices. Accordingly, the two network devices are configured to implement the high layer protocols. The network devices may be configured to use one or more of the higher-layer protocols to define packets encapsulating signaling information and define packets encapsulating data. These packets may be multiplexed together on a first physical medium connecting the two devices or sent on separate physical mediums.

Thus, typically, to exchange signaling information using one or more higher-layer protocols between two devices that are exchanging data on a first channel, a separate second channel is created for the signaling information. This second channel may either be multiplexed with the first channel on a first physical medium connecting the two devices, or sent on a separate physical medium connecting the two devices.

Often, for data exchanged between network devices located external to an Optical Transport Network (OTN), referred to herein as User Devices (UDs), the data is transmitted across the OTN. An OTN is a network in which all of the network transmission links between network devices are optical transmission links, for example, fiber optic cables, although one or more of the network devices, for example, Optical Cross-Connects (OXCs) and Add/Drop Multiplexers (ADMs), may process the transmitted signals non-optically.

To transmit the data across the OTN, the data is transmitted to and between one or more devices included as part of the OTN, referred to herein as Transport Network Devices (TNDs). Typically, a TND is configured to implement merely the physical layer functions of any protocols, for example, GE, being used to exchange data between the two UDs, and is not configured to implement the higher layers of any of the protocols, including the Data Link (e.g., the MAC layer of the GE protocol), Network, Transport and Session layers.

Thus, for a typical TND to exchange signaling information with a UD or other TNDs, the TND is re-configured to implement more than merely the physical layer of a protocol being used to exchange data, for example, at least the Data Link Layer of the protocol.

Further, if the Data Link Layer of the protocol being used to exchange data does not provide bytes for specifying signaling information, then the TND may be further reconfigured to implement other higher-layer protocols to exchange the signaling information, as described above.

### SUMMARY

Provided herein is a method and system for encoding signaling information at a physical layer of a network protocol, for example, an Ethernet-based protocol such as Gigabit Ethernet (GE). On a first network device, the signaling information may be encoded and multiplexed with data encoded according to a first block coding scheme to produce a stream of data encoded according to the first block coding scheme. The signaling information may be encoded using bit sequences not defined for use by the first block coding scheme. This stream of data then may be transmitted on a network medium to another network device, which then may extract the bit sequences encoding the signaling information from the stream of data and decode the bit sequences into the signaling information.

Thus, for two devices exchanging data on a first channel, signaling information may be multiplexed within this first channel itself, rather than sent on a separate channel. Further, to exchange signaling information, the two devices do not have to implement a protocol or part of a protocol at a layer higher than the physical layer. As a result, the configuration of these two devices is simplified.

In an illustrative embodiment, signaling information is transmitted from a first device to a second device, where data transmitted between the first device and the second device is encoded in accordance with a first block coding scheme. The signaling information is encoded as one or more first sequences of bits. The one or more first sequences of bits are multiplexed with first data encoded in accordance with the first block coding scheme to produce a first stream of data encoded in accordance with the first block coding scheme. The first stream of data is transmitted from the first device to the second device.

This illustrative embodiment may be implemented as a computer program product that includes a computer-readable medium and computer-readable signals stored on the computer-readable medium, which signals define appropriate instructions. These instructions, as a result of being executed by a computer, instruct the computer to perform the Acts described above for this illustrative embodiment.

In another illustrative embodiment. a system for transmitting signaling information from a first device to a second device is provided, where data transmitted between the first device and the second device is encoded in accordance with a first block encoding scheme. The system includes the first device. The first device includes an encoder to encode the signaling information as one or more first sequences of bits, and a multiplexer to multiplex the one or more first sequences of bits with first data encoded in accordance with the first block coding scheme to produce a first stream of data encoded in accordance with the first block coding scheme. The system further includes an output to transmit the first stream of data from the system to a device.

In yet another illustrative embodiment, signaling information is extracted from a first stream of data encoded in accordance with a first block coding scheme. The signaling information has been encoded as one or more first sequences of bits and multiplexed with other data encoded in accordance with the first block coding scheme to produce the first stream of data. The first stream of data is received, and the one or more first sequences of bits are de-multiplexed from the first stream of data. The one or more first sequences of bits are decoded into the signaling information.

This illustrative embodiment may be implemented as a computer program product that includes a computer-readable medium and computer-readable signals stored on the computer-readable medium, which signals define appropriate instructions. These instructions, as a result of being executed by a computer, instruct the computer to perform the Acts described above for this illustrative embodiment.

In another illustrative embodiment, a system for extracting signaling information from a first stream of data encoded in accordance with a first block coding scheme is provided. The signaling information has been encoded as one or more first sequences of bits and multiplexed with other data encoded in accordance with the first block coding scheme to produce the first stream of data. The system includes an input to receive the first stream of data, a demultiplexer to de-multiplex the one or more first sequences of bits from the first stream of data, and a decoder to decode the one or more first sequences of bits into the signaling information.

In another illustrative embodiment, signaling information is transmitted from a first device to a second device, where data transmitted between the first device and the second device is encoded in accordance with a first block encoding scheme. The signaling information is encoded as one or more first sequences of bits. The one or more first sequences of bits are multiplexed with first data encoded in accordance with the a first block encoding scheme to produce a first stream of data encoded in accordance with the a first block encoding scheme. The first stream of data is transmitted from the first device to the second device. The one or more first sequences of bits are de-multiplexed from the first stream of data, and the one or more first sequences of bits are decoded into the signaling information.

This illustrative embodiment may be implemented as a computer program product that includes a computer-readable medium and computer-readable signals stored on the computer-readable medium, which signals define appropriate instructions. These instructions, as a result of being executed by a computer, instruct the computer to perform the Acts described above for this illustrative embodiment.

In yet another illustrative embodiment, a system for transmitting signaling information from a first device to a second device is provided, where data transmitted between the first device and the second device is encoded in accordance with a first block encoding scheme. The system includes a first device and a second device. The first device includes an encoder to encode the signaling information as one or more first sequences of bits and a multiplexer to multiplex the one or more first sequences of bits with first data encoded in accordance with the first block encoding scheme to produce a first stream of data encoded in accordance with the first block encoding scheme. The first device also includes an output to transmit the first stream of data from the first device to the second device The second device includes an input to receive the first stream of data, a demultiplexer to de-multiplex the one or more first sequences of bits from the first stream of data and a decoder to decode the one or more first sequences of bits into the signaling information.

### BRIEF DESCRIPTION OF THE DRAWINGS

The features and advantages of the embodiments described above and other features and advantages of these embodiments will be more readily understood and appreciated from the detailed description below, which should be read together with the accompanying drawing figures.

In the drawings,

FIG. 1 is a flow chart of an illustrative embodiment of a method of transmitting signaling information from a first device to a second device by encoding the signaling information at a physical layer of a network protocol;

FIG. 2 is a flow chart of an illustrative embodiment of Act 6 of FIG. 1;

FIG. 3 is a flow chart of an illustrative embodiment of Act 14 of FIG. 1;

FIG. 4 is a block and data flow diagram of an illustrative embodiment of a system for transmitting signaling information from a first device to a second device by encoding the signaling information at a physical layer of a network protocol.

### DETAILED DESCRIPTION

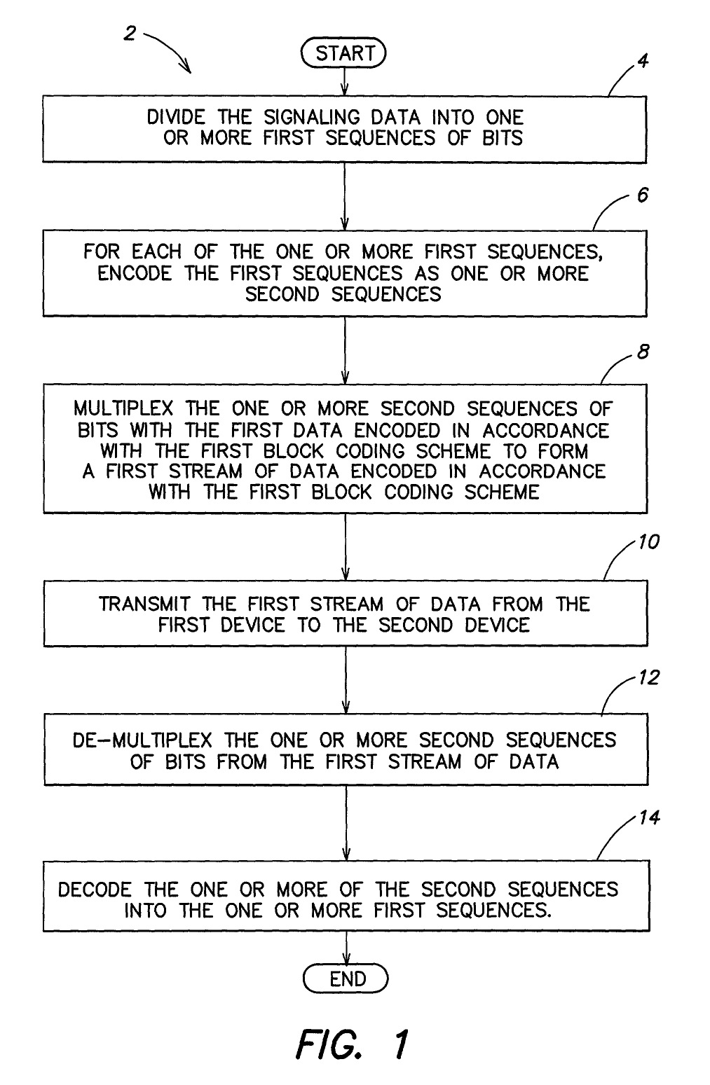

FIG. 1 is a flow chart of an illustrative embodiment of a method 2 of transmitting signaling information from a first device to a second device, where data transmitted between the first device and the second device is encoded according to a first block coding scheme, for example, 8B/10B. The first and second devices may exchange data using any of a variety of protocols, for example, an Ethernet-based protocol such as 10 Mb/s Ethernet, Fast Ethernet (100 Mb/s), Gigabit Ethernet (GE) (1000 Mb/s) or 10 GE Local Area Network (LAN) (10,000 Mb/s).

Each of these protocols may encode data at the physical layer of the protocol using different block coding schemes. For example, Fast Ethernet uses a 4B/5B block coding scheme as defined by the Fast Ethernet specification, GE uses a 8B/10B as defined by the GE specification, and 10 GE LAN uses a 64B/66B block coding scheme as defined by the 10 GE LAN protocol currently under development.

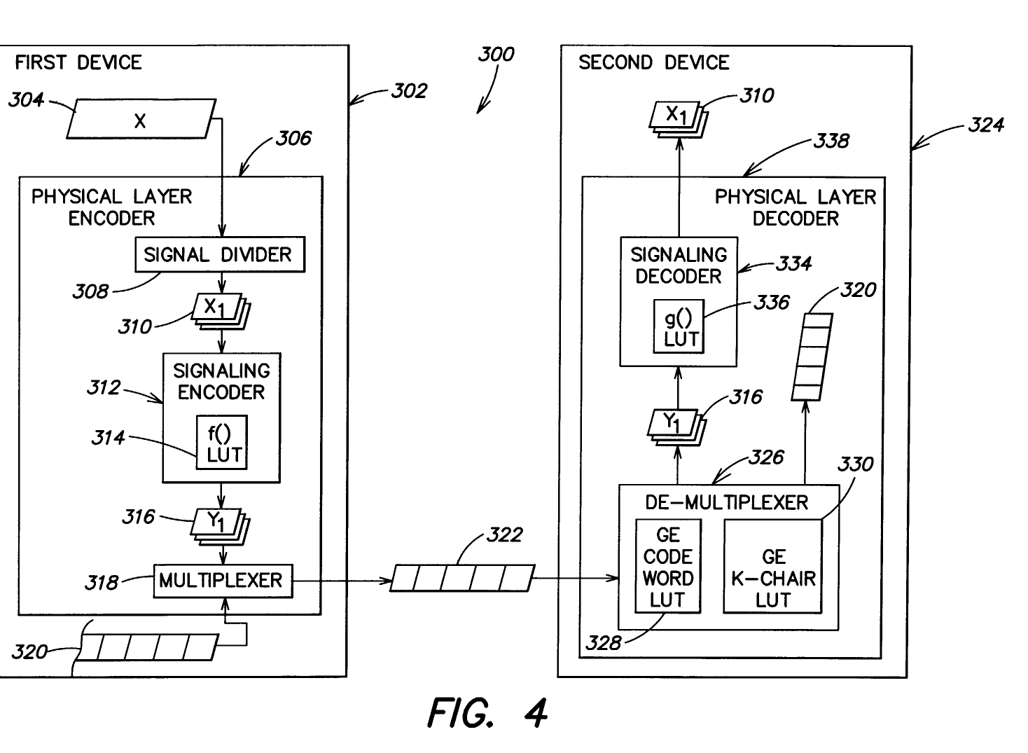

Both the first device and the second device may be any of a variety of network devices, as described below in more detail in relation to FIG. 4.

In Act 4, the signaling information may be divided into one or more first sequences of bits. If the first block coding scheme is 8B/10B, then the signaling information may be divided into one or more first 8-bit sequences of bits, for example, 01111010.

Next, in Act 6, for each of the one or more first sequences, the first sequence is encoded as one or more second sequences of bits. If the first block coding scheme is 8B/10B then a first sequence of eight bits may be encoded as one or more second 10-bit sequences, for example, 1101111010.

If the first block coding scheme is 8B/10B as defined by the GE specification, then each first sequence may be encoded as one or more 10-bit second sequences that are not assigned for use by the GE specification. Further, each first sequence may be encoded as a 10-bit second sequence that has a Hamming weight not equal to four, five, or six, which, as described above, are the Hamming weights for all the 8B/10B code words and K-characters established by the GE specification. In other words, each first sequence may be encoded as one or more 10-bit second sequences having a Hamming weight of zero, one, two, three, seven, eight, nine, or ten.

There are three hundred fifty-two 10-bit sequences that satisfy this Hamming weight constraint. Accordingly, to convert each first sequence to one or more 10-bit sequences, any encoding function may be applied that produces one of these three hundred fifty-two 10-bit sequences for a possible first sequence. Optionally, such an encoding function may be implemented by using a look-up table (LUT). Each entry of the LUT may correspond to a possible first sequence of bits, and each entry may contain the 10-bit sequence for the corresponding possible first sequence in accordance with applying the encoding function.

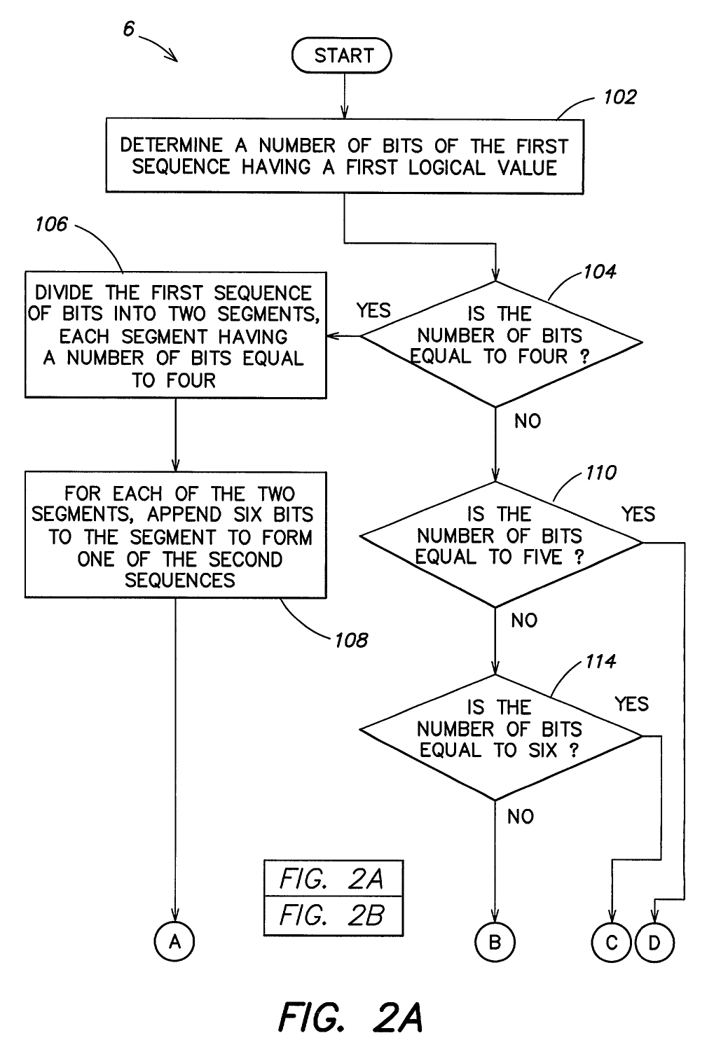

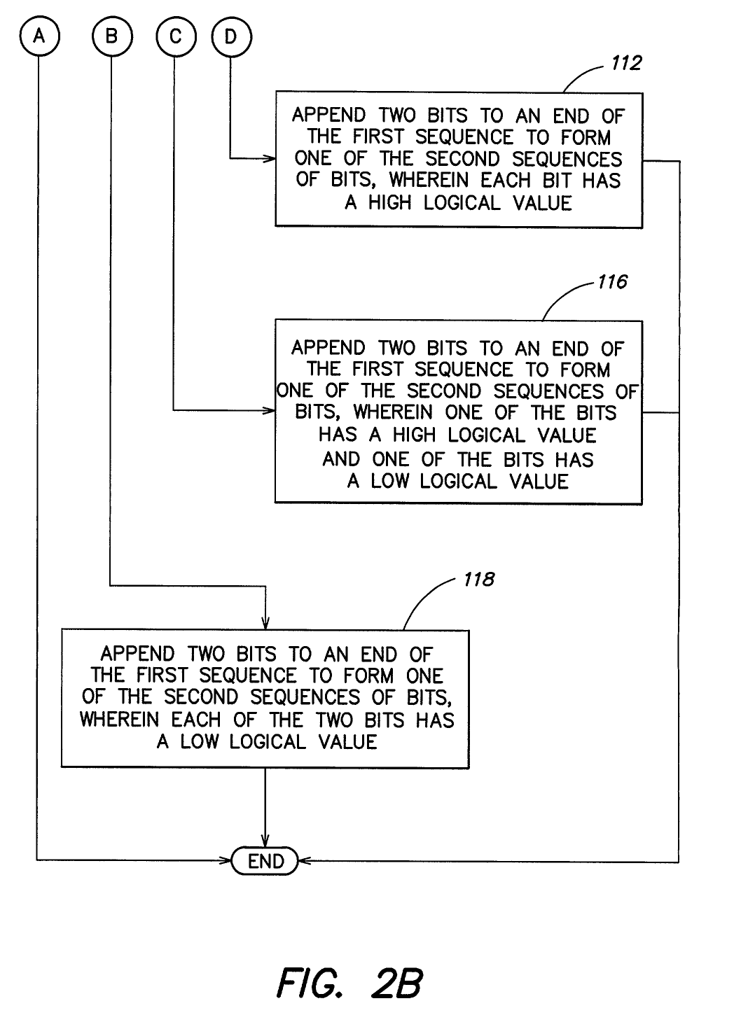

FIG. 2 is a flow chart of an illustrative embodiment of Act 6, where the first block coding scheme is 8B/10B.

In Act 102, the number of bits of the first sequence having a first logical value, for example, a high logical value (i.e., “1”), may be determined. Next, in Act 104, it may be assessed whether the number of bits determined in Act 102 is equal to four.

As an alternative to determining the number of high logical values, “1”s in Act 102, it may be determined how many bits have a low logical value (i.e., “0”). Because each first sequence has eight bits, if the number of “0”s is determined, then the number of “1”s can be derived by subtracting the number of “0”s from eight. Therefore, either determination may be made to determine eventually the number of “1”s.

Similarly, in Act 104, and any other act in which the number of determined bits is assessed, e.g., Acts 110 and 114, as an alternative to assessing whether the number of “1”s is equal to a first number, it may be determined whether the number of “0”s is equal to the “8”s-complement of the first number (i.e., eight minus the first number). For example, in Act 110, as described below, it may be assessed whether the number of “1”s is equal to five. Alternatively, in Act 110, it may be assessed whether the number of “0”s is equal to three (eight minus five).

If it is assessed in Act 104 that the determined number of bits having a first logical value is equal to four, then in Act 106, the first sequence of bits may be divided into two segments, each segment having a number of bits equal to four, and in Act 108, for each segment, six bits may be appended to a first end of the segment to form one of the second sequences. For each segment, the six bits appended to the first end of the segment may be selected such that a combination of the six bits and the segment has a Hamming weight less than four or greater than six.

For example, if the first sequence of bits is 11110000, then in Act 106, the first sequence may be divided into a first segment 1111 and a second segment 0000. For the first segment 1111, the six bits 010101 may be added to the first segment to form a second sequence 0101011111, which has a Hamming weight equal to seven. For the second segment 0000, the six bits 010000 may be appended to the second segment to form the second sequence 0100000000, which has a Hamming weight equal to one.

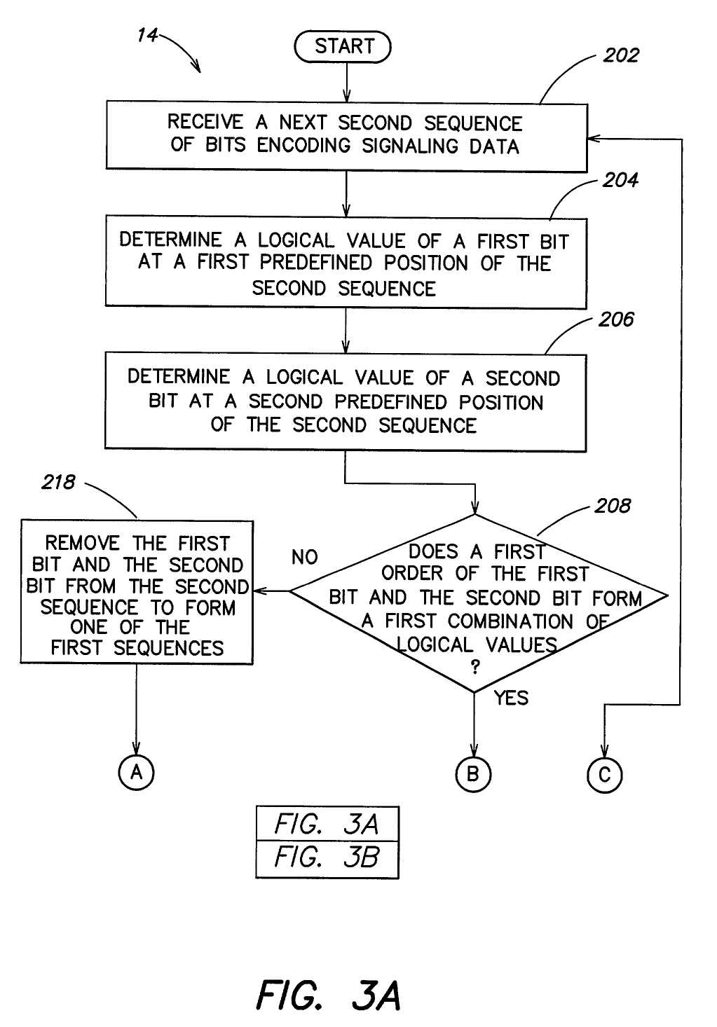

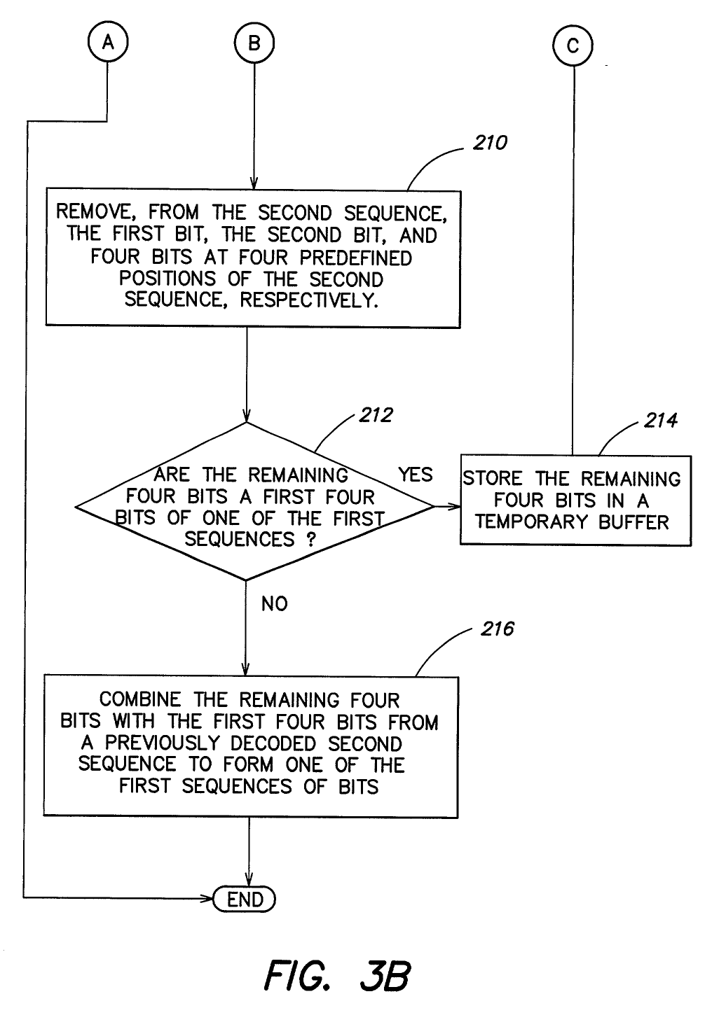

As will be discussed in more detail below in relation to FIG. 3, of the six bits appended to the two segments, two of the bits, for example, the first two bits, may be designated to indicate that the second sequence was formed by dividing a first sequence into two segments and appending six bits to each segment. For example, using the bits specified above, for the six bits added to each segment, the first two bits of the six bits is “01” . Therefore, these two bits “01” may indicate that the second sequence was formed by dividing a first sequence into two segments and appending six bits to each segment. Although the bit combination “01” is used above, other bit combinations may be used for such an indication.

If it is determined in Act 104 that the number of bits is not equal to four, then, in Act 110, it may be assessed whether the number of bits determined to have a first logical value in Act 102 is equal to five.

If it is assessed in Act 110 that the number of bits having a first logical value is equal to five, then in Act 112, two bits may be appended to an end of the first sequence to form one of the second sequences of bits, wherein both of the two bits has a high logical value. For example, if the first sequence equals 11101100, then in Act 112, the bits “11” may be appended to an end of the first sequence to form a 10-bit sequence 111110110, which has a Hamming weight equal to seven.

If it is assessed in Act 110 that the number of bits have a first logical value is not equal to five, then, in Act 114, it may be assessed whether the number of bits determined to have a first logical value in Act 102 is equal to six If it is assessed in Act 114 that the number of bits determined having a first logical value is equal to six, then, in Act 116, two bits may be appended to an end of the first sequence to form one of the second sequences of bits, where one of the two bits has a high logical value and one of the two bits has a low logical value. For example, if the 8-bit first sequence is 11011011, then in Act 116, the bits “10” may be appended to an end of the first sequence to form a 10-bit sequence 1011011011, which has a Hamming weight equal to seven.

If, in accordance with Act 116, one of the two bits has a high logical value and one of the two bits has a low logical value, this 2-bit sequence should be selected to be different than the 2-bit sequence included in the six bits appended to a segment in Act 108. As will be described below in more detail in relation to FIGS. 3 and 4, when a second sequence is decoded into at least part of a first sequence, for example, by a signal decoder, two bits of the 10-bit second sequence (e.g., the first two bits), may be examined to determine how to decode the 10-bit second sequence.

Alternatively, the two bits appended to an end of the first sequence in Act 116 both may have a high logical value to produce a second sequence of bits that has a Hamming weight equal to eight.

If it is assessed in Act 114 that the number of bits determined to have a first logical value is not equal to six, then, in Act 118, two bits may be appended to an end of the first sequence to form one of the second sequences of bits, where each of the two bits has a low logical value. In other words, by performing Acts 104, 110 and 114, it has been determined that the first sequence does not have a number of bits having a first logical value equal to four, five or six. Accordingly, to produce a second sequence having a Hamming weight greater than six or less than four, the bits “00” may be appended to the end of the first sequence.

For example, if the first sequence is 10000001 or 11111111, then, in Act 118, the bits “00” may be appended to an end of the first sequence to form a 10-bit sequence 0010000001 or 0011111111, respectively, where each second sequence would have a Hamming weight greater than six or less than four.

The method of Act 6 for encoding each first sequence as one or more second sequences is provided for illustrative purposes, as several other encoding algorithms may be applied to encode signaling information as one or more 10-bit second sequences that have Hamming weights greater than 6 or less than 4. For example, the order of Acts 104, 110 and 114, and the acts resulting from these acts, may be changed. Further, depending on the block coding scheme being used, for example, 4B/5B or 64B/66B, any of a variety of other signal encoding algorithms may be used to produce second sequences that are not reserved for use by the block coding scheme.

Returning to FIG. 1, in Act 8, the one or more second sequences of bits are multiplexed with first data encoded in accordance with the first block coding scheme to produce a first stream of data encoded in accordance with the first block coding scheme. For example, if the first block coding scheme is 8B/10B as defined by the GE specification, then the one or more second sequences of bits may be multiplexed with one or more GE code words and K-characters. Any of a variety of types of multiplexing may be used to produce the first stream, for example, statistical multiplexing.

For second sequences divided into two segments, where six bits are appended to each segment to produce one of the second sequences, the two second sequences produced may be multiplexed into the first stream of data such that the two second sequences are adjacent consecutive sequences or such that the two second sequences are not consecutive, but are separated by other 10-bit sequences, for example, GE code words or K-characters.

In a following Act 10, the first stream of data is transmitted from the first device to the second device on a network medium. The first stream of data may be transmitted on any of a plurality of network mediums, for example, an electrical, optical or wireless medium.

Next, in Act 12, the one or more second sequences are de-multiplexed from the first stream of data.

Typically, in the prior art, a network device (e.g., a GE switch) configured to implement a network protocol includes a physical layer decoder that decodes the data stream and detects any error in the bit sequences of the data stream. For example, for a network device implementing GE, the device may be configured to determine when a “running disparity error” or a “code word violation” has occurred, as described in more detail in the Seifert reference. A running disparity error occurs if the difference between the number of bits received having a first logical value (i.e., “1”) and the number of bits received having a second logical value (i.e., “0”) in the bit stream exceeds a predefined number, for example, two. A code word violation is generated if the decoder generates, as a result of applying an appropriate decoding algorithm, a 10-bit sequence of bits that is not a GE code word or a K-character.

Accordingly, to perform Act 12, the second device that receives the first stream of data may be configured such that, rather than generating a running disparity error or code word violation when one of the second sequences is produced by decoding, the second device sends each second sequence of bits produced to a signaling decoder that performs Act 14.

In a following Act 14, the one or more second sequences are decoded into the one or more first sequences. If the first block coding scheme is 8B/10B, then Act 14 may decode the one or more 10-bit second sequences into one or more 8-bit first sequences.

FIG. 3 is a flowchart of an illustrative embodiment of Act 14, where the first block coding scheme is 8B/10B as defined by the GE specification.

In Act 202, a next second sequence of bits that encodes signaling information is received.

In a next Act 204, a logical value of a logical bit at a first predefined position of the second sequence is determined, and in Act 206, a logical value of a second bit at a second predefined position of the second sequence is determined. For example, the first bit and the second bit may be bits at the first and second position, respectively, of the second sequence. The first bit and second bit should be the two bits appended in Act 112, 116 or 118, or, of the six bits appended in Act 108, the first bit and second bit should be the two bits that indicate that the first sequence from which the second sequence was created was divided into two segments and each segment had six bits appended thereto. For example, if the two bits as part of Acts 108, 112, 116 and 118 are the first two bits of the second sequence, then, in Acts 204 and 206, the first two bits of the second sequence should be analyzed.

In a next Act 208, it is determined whether a first order of the first bit and the second bit forms a first combination of logical values. For example, if the combination of “01” is designated to specify that the second sequence was created by splitting a first sequence into two segments and appending six bits to each segment, then, in Acts 208, it may be determined whether the first order of the first bit and the second bit forms “01”.

If it is determined in Act 208 that the first order does not form the first combination, then, in Act 218, the first bit and the second bit may be removed from the second sequence to produce one of the first sequences. The removed first bit and second bit should be the two bits appended in Act 112, 116 or 118.

If it is determined in Act 208 that the first order does form the first combination, then, in Act 210, the first bit, the second bit and four bits at four predefined positions of the second sequence are removed from the second sequence. These four bits should be the four bits of the six bits appended in Act 108 that provide the second sequence with the desired Hamming weight. By removing these bits, the remaining bits should correspond to a segment which was divided from a first sequence in Act 106.

In a following Act 212, it is determined whether the remaining four bits are a first four bits of one of the first sequences, as opposed to a second four bits of one of the first sequences.

If it is determined in Act 212 that the remaining four bits are not the first four bits of one of the first sequences, but are a second four bits of one of the first sequences, then, in Act 216, the remaining four bits are combined with the first four bits that were decoded from a previous second sequence, thus forming one of the first sequences of bits. For example, the four bits from a previously decoded second sequence may be stored in a temporary buffer (e.g., a register or an array), and Act 216 may include retrieving the four bits from the buffer and appending the remaining four bits to these retrieved four bits to form the first sequence of bits. Other techniques may be used to combine the remaining four bits with the previous four bits.

In Act 212, the determination may be made by applying any of a variety of techniques, for example, by determining whether there are already four bits stored in the temporary buffer, by determining the value of a variable such as a flag, or by determining the value of a register location.

If it is determined in Act 212 that the remaining four bits are a first four bits of one of the first sequences, then, in Act 214, the remaining four bits are stored in the temporary buffer, and the next sequence of bits encoding signaling information is received in Act 202.

The method of Act 14 for decoding each second sequence into at least part of a first sequence is provided for illustrative purposes, as several other decoding algorithms may be applied to decode signaling information that has been encoded as one or more 10-bit sequences that have Hamming weights greater than 6 or less than 4. Further, depending on the block coding scheme being used, for example, 4B/5B or 64B/66B, any of a variety of other signal decoding algorithms may be used to produce at least part of a first sequence from a second sequence of bits not reserved for use by the block coding scheme.

Although described above in relation to FIGS. 1-3 are various techniques for encoding signaling information at a physical layer of a protocol, other information also may encoded at the physical layer of a protocol using the same or similar techniques. For example, control words corresponding to a protocol could be encoded as a bit sequences not defined for use by the block coding scheme defined by the protocol. For example, if the block coding scheme is 8B/10B as defined by the GE specification, 10-bit code sequences not defined for use by the GE specification, may be used to encode control words of a signaling protocol, for example, start-of-frame, end-of-frame, initiate, end session, error propagation alerts, and frame check sequences.

FIG. 4 is a block and data flow diagram of an illustrative embodiment of a system 300 for transmitting signaling information from a first device to a second device, where data transmitted between the first device and the second device is encoded according to a first block coding scheme.

The system 300 may include a first device 302 and a second device 324. The first device 302 may include a signal divider 308, a signal encoder 312 and a multiplexer 318. Elements 308, 312 and 318 may be configured as part of the first device 302 in any of a variety of configurations, for example, as part of a physical layer encoder 306.

The signal divider 308 receives the signaling information 304 and divides the signaling information into one or more first sequences of bits 310, for example, as described above in relation to Act 4 of FIG. 1.

The signaling encoder 312 receives the one or more first sequences 310 and generates one or more second sequences 316, for example, by applying a signal encoding algorithm such as that described above in relation to Act 6 of FIGS. 1 and 2. To generate the one or more second sequences, the signaling encoder 312 may include or have access to a first LUT 314 that includes a plurality of entries. Each entry of the first LUT 314 may correspond to a possible first sequence of the one or more first sequences 310 and may contain one or more second sequences (of the one or more second sequences 316) that corresponds to the possible first sequence.

The first LUT 314 may have been loaded by pre-applying a signal encoding algorithm, for example, as described in relation to Act 6 of FIGS. 1 and 2, to each first sequence and storing the resulting second sequence in an entry of the first LUT 314, where the entry is assigned to the received first sequence.

Accordingly, when the signaling encoder 312 receives a first sequence, the multiplexer may access the entry of the first LUT corresponding to the first sequence and extract the one or more second sequences corresponding to the first sequence. Subsequently, the signaling encoder 312 may output the one or more retrieved second sequences as one or more of the second sequences 316.

The multiplexer 318 may receive the one or more second sequences 316 and first data encoded in accordance with the first block coding scheme, for example, one or more third sequences 320, and multiplex the one or more second sequences 316 and the first data to produce a first stream of data 322 encoded in accordance with the first block coding scheme.

The second device 324 may include a signaling decoder 334 and a demultiplexer 326. Elements 334 and 326 may be configured as part of the second device in any of a variety of configurations, for example, as part of a physical layer decoder 338.

The demultiplexer 326 receives the first stream of data 322 and de-multiplexes the first stream of data to produce the one or more second sequences 316, for example, as described above in relation to Act 12 of FIG. 1.

If the first block coding scheme is the 8B/10B scheme defined by the GE specification, the demultiplexer 326 may apply the decoding algorithm specified by GE to determine which 10-bit sequences of the first stream of data 322 are valid GE code words and K-characters that correspond to the first data 320 multiplexed by the multiplexer 318. The multiplexer 326 may be configured to output the first data 320 which may include GE code words and K-characters, and to output any words not recognized as GE code words and K-characters as the one or more second sequences of bits 316.

To implement the decoding algorithm specified by GE, the demultiplexer may include or have access to a GE code word LUT 328 and a GE K-character LUT 330. The GE code word LUT 328 may have a plurality of entries, where each entry corresponds to a 10-bit GE code word, and where each entry contains the 8-bit sequence of data corresponding to the 10-bit code word.

The GE K-character LUT 330 may include a plurality of entries, where each entry corresponds to a 10-bit K-character and may contain data corresponding to the 10 bit K-character.

When the demultiplexer 326 receives the first stream of data 322, for each 10-bit sequence of the first stream 322, the demultiplexer 326 may search the GE code word LUT 328 to determine if any of the entries of the GE code word LUT 328 correspond to the 10-bit sequence. If one of the entries does correspond to the 10-bit sequence, the demultiplexer 326 may retrieve the 8-bit sequence corresponding to the 10-bit code word from the entry and output the sequence as one of the 8-bit sequences of the first data 320.

If the demultiplexer 326 determines that none of the entries of the GE code word LUT 328 corresponds to the 10-bit sequence, then the demultiplexer 326 may then search the GE K-character LUT 330 to determine if any of the entries of the K-character LUT 330 correspond to the 10-bit sequence. If the demultiplexer 326 determines that one of the entries of the GE K-character LUT 330 does correspond to the 10-bit sequence, then the demultiplexer 326 may retrieve the data corresponding to the K-character from the entry and output the K-character data as part of the first data 320.

If the demultiplexer 326 determines that none of the entries of the GE K-character LUT 330 correspond to the 10-bit sequence, then the demultiplexer 326 may output the 10-bit sequence as one of the second sequences 316.

The signaling decoder 334 receives the one or more second sequences 316 and decodes the one or more second sequences 316 to produce the one or more first sequences 310, for example, by applying a signal decoding algorithm such as that as described above in relation to Act 14 of FIGS. 1 and 3. To decode the one or more second sequences 316, the signaling decoder 334 may include or have access to a second LUT 336, which includes a plurality of entries. Each entry of the second LUT 336 may correspond to a second sequence of the one or more second sequences 316, and may contain a first sequence of the one or more first sequences 310 that corresponds to the second sequence.

The second LUT 336 may have been loaded by pre-applying a signal decoding algorithm, for example, as described in relation to Act 14 of FIGS. 1 and 3, to each second sequence and storing the resulting first sequence (or at least part of a first sequence) in an entry of the second LUT 336, where the entry is assigned to the received second sequence.

Accordingly, when the signaling decoder 334 receives a second sequence 316, the signaling decoder 334 may access an entry of the second LUT 336 that corresponds to the second sequence, and retrieve the first sequence from the entry. The signaling decoder then may output the first sequence from the entry as one of the first sequences 310.

Both the first device and the second device may be any of a variety of types of network devices capable of transmitting and receiving data in accordance with a LAN protocol. Such networking devices may include, among other devices, an Internet Protocol (IP) router such as the M40/1160 available from Juniper Networks, Inc. of Sunnyville, Calif., an Asynchronous Transfer Mode (ATM) switch such as the GX550 available from Lucent Technologies of Murray Hill, N.J., a GE-enabled switch such as the SN 8000 available from Sycamore Networks of Chelmsford, Mass., an Optical Cross-Connect (OXC) such as the SN 16000 available from Sycamore Networks of Chelmsford, Mass. and an Add/Drop Multiplexer (ADM) such as the DDM available from Lucent Technologies of Murray Hill, N.J.

Further, one of the first device or second device may be User Device (UD), which is a network device external to an Optical Transport Network (OTN). and one of the first device or second device may be a Transport Network Device (TND), which is a network device included as part of an Optical Transport Network (OTN). An OTN is a network in which all of the network transmission links between network devices are optical transmission links, for example, fiber optic cables, although one or more of the network devices, for example, OXCs and ADMs, may process the transmitted signals non-optically.

The system 300 is merely an illustrative example of a system for transmitting signaling information from a first device to a second device, where data transmitted between the first device and the second device is encoded according to a first block coding scheme. Variations of the system 300 and other systems may be used to implement the methods and techniques described above in relation to FIGS. 1-3.

The signaling information encoded as part of the first stream of data, as described above, may include signaling requests specified by the Optical Domain Servers Interconnect (ODSI), as promulgated by the ODSI Coalition. The ODSI Coalition has a web page at: http://www.odsi-coalition.com/documents.html, from which the most recent versions of various documents specifying different aspects of ODSI may be accessed.

To encode signaling information, or other information, as described above in relation to FIGS. 1-3, one or more devices, for example, the first device 302 and the second device 324 of FIG. 4, may be configured individually, or in combinations with logic to implement the encoding methods and techniques, or variations thereof, described above in relation to FIGS. 1-3. Such logic may be implemented using hardware (e.g., one or more application-specific integrated circuits) , firmware (e.g., electrically-programmable logic), software, or a combination thereof. Each such one or more devices may include, among other things, a plurality of known components such as one or more processors, a memory system, a disk storage system, one or more network interfaces connecting the device to network links that connect to network resources, components for processing (e.g., multiplexing, switching, routing, converting, etc.) network signals and data, and one or more busses or other internal communication links interconnecting the various components.

Having now described some illustrative embodiments, it should be apparent to those skilled in the art that the foregoing is merely illustrative and not limiting, having been presented by way of example only. Numerous modifications and other illustrative embodiments are within the scope of one of ordinary skill in the art and are contemplated as falling within the scope of the invention. In particular, although many of the examples presented herein involve specific combinations of method acts or system elements, it should be understood that those acts and those elements may be combined in other ways to accomplish the same objectives. Acts, elements and features discussed only in connection with one embodiment are not intended to be excluded from a similar role in other embodiments. Further, for the one or more means-plus-function limitations recited in the following claims, the means are not intended to be limited to the means disclosed herein for performing the recited function, but are intended to cover in scope any means, known now or later developed, for performing the recited function.

What is claimed is:

1. A method of transmitting signaling information from a first device to a second device, wherein data transmitted between the first device and the second device is encoded using a first block coding scheme, the method comprising acts of:
(A) encoding the signaling information as one or more first sequences of bits;
(B) multiplexing the one or more first sequences of bits with first data encoded in accordance with the first block coding scheme to produce a first stream of data encoded in accordance with the first block coding scheme; and
(C) transmitting the first stream of data from the first device to the second device.

2. The method of claim 1, wherein the method further comprises acts of:
(D) de-multiplexing the one or more first sequences of bits from the first stream of data; and
(E) decoding the one or more first sequences of bits into the signaling information.

3. The method of claim 1, wherein the first device is operative to transmit data according to a first protocol, and acts (A) and (B) are performed at a physical layer of the first protocol.

4. The method of claim 3, wherein the first protocol is an Ethernet-based protocol.

5. The method of claim 1, wherein act (A) comprises an act of:
encoding the signaling information such that each of the first sequences of bits is not a sequence of bits defined by the first block coding scheme.

6. The method of claim 1, wherein act (A) comprises acts of:
(1) dividing the signaling information into one or more second sequences of bits; and
(2) for each of the one or more second sequences, encoding the second sequence as one or more of the first sequences.

7. The method of claim 6, wherein the first block coding scheme is an 8B/10B block coding scheme, and act (A)(1) comprises an act of dividing the signaling information into one or more second sequences of eight bits, and act (A)(2) comprises an act of encoding each of the one or more second sequences of eight bits such that each of the first sequences of bits has a number of bits equal to ten.

8. The method of claim 7, wherein act (A)(2) further comprises an act of:
encoding each second sequence of bits such that each of the first sequences of bits is not a 10-bit code word defined by the 8B/10B block coding scheme.

9. The method of claim 7, wherein act (A)(2) comprises an act of:
encoding each second sequence such that, for each of the first sequences, a number of bits of the first sequence having a first logical value is either less than four or greater than six.

10. The method of claim 9, wherein the first logical value is a logical one.

11. The method of claim 9, wherein the first logical value is a logical zero.

12. The method of claim 9, wherein act (A)(2), for each second sequence of bits, comprises acts of:
(a) determining a number of bits of the second sequence having a first logical value; and
(b) generating one or more of the first sequences from the second sequence based on the number of bits of the first sequence having a first logical value such that, for each generated first sequence of bits, a number of bits having a first logical value is greater than six or less than four.

13. The method of claim 12, wherein, for each second sequence of bits, if the number of bits determined to have a first logical value is equal to four, act (A)(2)(b) further comprises acts of:
dividing the second sequence of bits into two segments having a number of bits equal to four; and
for each segment, appending six bits to a first end of the segment to produce one of the first sequences.

14. The method of claim 12, wherein, for each second sequence of bits, if the number of bits determined to have a first logical value is less than four or greater than six, act (A)(2) further comprises an act of:
appending two bits to an end of the second sequence to produce one of the first sequences of bits, wherein each of the two bits has a second logical value.

15. The method of claim 12, wherein, for each second sequence of bits, if the number of bits determined to have a first logical value is equal to five, act (A)(2) further comprises an act of:
appending two bits to an end of the second sequence to produce one of the first sequences of bits, wherein each bit has a first logical value.

16. The method of claim 12, wherein, for each second sequence of bits, if the number of bits determined to have a first logical value is equal to six, act (A)(2) further comprises an act of:
appending two bits to an end of the second sequence to produce one of the first sequences of bits, wherein one of the bits has a first logical value and one of the bits has a second logical value.

17. The method of claim 1, wherein the first device is a network device of an optical transport network, and the second device is a network device external to the optical transport network.

18. The method of claim 17, wherein the signaling information is defined in accordance with the Optical Domain Service Interconnect.

19. The method of claim 1, wherein the second device is a network device of an optical transport network, and the first device is a network device external to the optical transport network.

20. The method of claim 19, wherein the signaling information is defined in accordance with the Optical Domain Service Interconnect.

21. The method of claim 1, wherein the signaling information is defined in accordance with the Optical Domain Service Interconnect.

22. A system for transmitting signaling information from a first device to a second device, wherein data transmitted between the first device and the second device is encoded using a first block coding scheme, the system comprising:
the first device comprising an encoder to encode the signaling information as one or more first sequences of bits, a multiplexer to multiplex the one or more first sequences of bits with first data encoded in accordance with the first block coding scheme to produce a first stream of data encoded in accordance with the first block coding scheme, and an output to transmit the first stream of data from the first device to the second device.

23. The system of claim 22, wherein the system further comprises:
the second device comprising an input to receive the first stream of data, a demultiplexer to de-multiplex the one or more first sequences of bits from the first stream of data, and a decoder to decode the one or more first sequences of bits into the signaling information.

24. The system of claim 22, wherein the first device is operative to transmit data according to a first protocol, and to perform acts (A) and (B) at a physical layer of the first protocol.

25. The system of claim 24, wherein the first protocol is an Ethernet-based protocol.

26. The system of claim 22, wherein the encoder is operative to encode the signaling information such that each of the first sequences of bits is not a sequence of bits defined by the first block coding scheme.

27. The system of claim 22, wherein the first device further comprises
a signal divider to divide the signaling information into one or more second sequences of bits, and
wherein the encoder is further operative, for each of the one or more second sequences, to encode the second sequence as one or more of the first sequences.

28. The system of claim 27, wherein the first block coding scheme is an 8B/10B block coding scheme, and the signal divider is operative to divide the signaling information into one or more second sequences of eight bits, and the encoder is further operative to encode each of the one or more second sequences of eight bits such that each of the first sequences of bits has a number of bits equal to ten.

29. The system of claim 28, wherein the encoder is further operative to encode each second sequence of bits such that each of the first sequences of bits is not a 10-bit code word defined by the 8B/10B block coding scheme.

30. The system of claim 28, wherein the encoder is further operative to encode each second sequence such that, for each of the first sequences, a number of bits of the first sequence having a first logical value is either less than four or greater than six.

31. The system of claim 30, wherein the first logical value is a logical one.

32. The system of claim 30, wherein the first logical value is a logical zero.

33. The system of claim 30, wherein the encoder is further operative, for each second sequence of bits, to determine a number of bits of the second sequence having a first logical value, and to generate one or more of the first sequences from the second sequence based on the number of bits of the first sequence having a first logical value such that, for each generated first sequence of bits, a number of bits having a first logical value is greater than six or less than four.

34. The system of claim 33, wherein the encoder is further operative, for each second sequence of bits, if the number of bits determined to have a first logical value is equal to four, to divide the second sequence of bits into two segments having a number of bits equal to four, and, for each segment, append six bits to a first end of the segment to produce one of the first sequences.

35. The system of claim 33, wherein the encoder is further operative, for each second sequence of bits, if the number of bits determined to have a first logical value is less than four or greater than six, to append two bits to an end of the second sequence to produce one of the first sequences of bits, wherein each of the two bits has a second logical value.

36. The system of claim 33, wherein the encoder is further operative, for each second sequence of bits, if the number of bits determined to have a first logical value is equal to five, to append two bits to an end of the second sequence to produce one of the first sequences of bits, wherein each bit has a first logical value.

37. The system of claim 33, wherein, the encoder is further operative, for each second sequence of bits, if the number of bits determined to have a first logical value is equal to six, to append two bits to an end of the second sequence to produce one of the first sequences of bits, wherein one of the bits has a first logical value and one of the bits has a second logical value.

38. The system of claim 22, wherein the first device is a network device of an optical transport network, and the second device is a network device external to the optical transport network.

39. The system of claim 38, wherein the signaling information is defined in accordance with the Optical Domain Service Interconnect.

40. The system of claim 22, wherein the second device is a network device of an optical transport network, and the first device is a network device external to the optical transport network.

41. The system of claim 40, wherein the signaling information is defined in accordance with the Optical Domain Service Interconnect.

42. The system of claim 22, wherein the signaling information is defined in accordance with the Optical Domain Service Interconnect.

43. A system for transmitting signaling information from a first device to a second device, wherein data transmitted between the first device and the second device is encoded using a first block coding scheme, the system comprising:
means for encoding the signaling information as one or more first sequences of bits;
means for multiplexing the one or more first sequences of bits with first data encoded in accordance with the first block coding scheme to produce a first stream of data encoded in accordance with the first block coding scheme; and
means for transmitting the first stream of data from the first device to the second device.

44. The system of claim 43, wherein the system further comprises:
means for de-multiplexing the one or more first sequences of bits from the first stream of data; and
means for decoding the one or more first sequences of bits into the signaling information.

45. The system of claim 43, wherein the first device is operative to transmit data according to a first protocol, the means for encoding comprises means to encode at a physical layer of the first protocol, and the means for multiplexing comprises means to multiplex at the physical layer of the first protocol.

46. The system of claim 3, wherein the first protocol is an Ethernet-based protocol.

47. The system of claim 43, wherein the means for encoding comprises:
means for encoding the signaling information such that each of the first sequences of bits is not a sequence of bits defined by the first block coding scheme.

48. The system of claim 43, wherein the system further comprises:
means for dividing the signaling information into one or more second sequences of bits, and
wherein means for encoding comprises means for encoding, for each of the one or more second sequences, the second sequence as one or more of the first sequences.

49. The system of claim 48, wherein the first block coding scheme is an 8B/10B block coding scheme, the means for dividing comprises means for dividing the signaling information into one or more second sequences of eight bits, and the means for encoding further comprises means for encoding each of the one or more second sequences of eight bits such that each of the first sequences of bits has a number of bits equal to ten.

50. The system of claim 49, wherein the means for encoding further comprises:
means for encoding each second sequence of bits such that each of the first sequences of bits is not a 10-bit code word defined by the 8B/10B block coding scheme.

51. The system of claim 49, wherein the means for encoding further comprises:
means for encoding each second sequence such that, for each of the first sequences, a number of bits of the first sequence having a first logical value is either less than four or greater than six.

52. The system of claim 51, wherein the first logical value is a logical one.

53. The system of claim 51, wherein the first logical value is a logical zero.

54. The system of claim 51, wherein the means for encoding further comprises, for each second sequence of bits:
means for determining a number of bits of the second sequence having a first logical value; and
means for generating one or more of the first sequences from the second sequence based on the number of bits of the first sequence having a first logical value such that, for each generated first sequence of bits, a number of bits having a first logical value is greater than six or less than four.

55. The system of claim 54, wherein the means for encoding further comprises, for each second sequence of bits, if the number of bits determined to have a first logical value is equal to four:
means for dividing the second sequence of bits into two segments having a number of bits equal to four; and
means for appending, for each segment, six bits to a first end of the segment to produce one of the first sequences.

56. The system of claim 54, wherein the means for encoding further comprises, for each second sequence of bits, if the number of bits determined to have a first logical value is less than four or greater than six:
means for appending two bits to an end of the second sequence to produce one of the first sequences of bits, wherein each of the two bits has a second logical value.

57. The system of claim 54, wherein the means for encoding further comprises, for each second sequence of bits, if the number of bits determined to have a first logical value is equal to five
means for appending two bits to an end of the second sequence to produce one of the first sequences of bits, wherein each bit has a first logical value.

58. The system of claim 54, wherein the means for encoding further comprises, for each second sequence of bits, if the number of bits determined to have a first logical value is equal to six:
means for appending two bits to an end of the second sequence to produce one of the first sequences of bits, wherein one of the bits has a first logical value and one of the bits has a second logical value.

59. The system of claim 54, wherein the first device is a network device of an optical transport network, and the second device is a network device external to the optical transport network.

60. The system of claim 59, wherein the signaling information is defined in accordance with the Optical Domain Service Interconnect.

61. The system of claim 43, wherein the second device is a network device of an optical transport network, and the first device is a network device external to the optical transport network.

62. The system of claim 61, wherein the signaling information is defined in accordance with the Optical Domain Service Interconnect.

63. The system of claim 43, wherein the signaling information is defined in accordance with the Optical Domain Service Interconnect.

64. A computer program product, comprising:
a computer-readable medium; and
computer-readable signals stored on the computer-readable medium that define instructions that, as a result of being executed by a computer, instruct the computer to perform a process of transmitting signaling information from a first device to a second device, wherein data transmitted between the first device and the second device is encoded using a first block coding scheme, the process comprising acts of:
(A) encoding the signaling information as one or more first sequences of bits;
(B) multiplexing the one or more first sequences of bits with first data encoded in accordance with the first block coding scheme to produce a first stream of data encoded in accordance with the first block coding scheme; and
(C) transmitting the first stream of data from the first device to the second device.

65. A method of extracting signaling information from a first stream of data encoded in accordance with a first block coding scheme, wherein the signaling information has been encoded as one or more first sequences of bits and multiplexed with first data encoded in accordance with the first block coding scheme to produce the first stream of data, the method comprising acts of:
(A) receiving the first stream of data;
(B) de-multiplexing the one or more first sequences of bits from the first stream of data; and
(C) decoding the one or more first sequences of bits into the signaling information.

66. The method of claim 65, wherein the first device is operative to exchange data according to a first protocol, and acts (B) and (C) are performed at a physical layer of the first protocol.

67. The method of claim 66, wherein the first protocol is an Ethernet-based protocol.

68. The method of claim 65, wherein the signaling information had been divided into one or more second sequences of bits, and the one or more second sequences of bits has been encoded as the one or more first sequences, and act (C) comprises an act of:
(1) decoding the one or more of the first sequences into one or more second sequences

69. The method of claim 68, wherein the first block coding scheme is an 8B/10B block coding scheme, the signaling information had been divided into one or more second sequences of eight bits, and each of the one or more second sequences of eight bits has been encoded such that each of the first sequences of bits has a number of bits equal to ten.

70. The method of claim 69, wherein, for each first sequence of bits, act (C)(1) comprises acts of:
(a) determining a first value of a first bit at a first predefined position of the first sequence;
(b) determining a second value of a second bit at a second predefined position of the first sequence; and
(c) generating, from each first sequence of bits, at least part of one of the second sequences of bits based on the first value and the second value.

71. The method of claim 70, wherein, for each first sequence of bits, if it is determined in acts (C)(1)(a) and (b) that a first order of the first bit and the second bit forms a first combination of values, then act (C)(1)(c) further comprises acts of:
removing, from the first sequence, the first bit, the second bit, and four bits at four predefined positions of the first sequence, respectively; and
combining the remaining four bits with four bits from another first sequence to produce one of the second sequences of bits.

72. The method of claim 70, wherein, for each first sequence of bits, if it is determined in acts (C)(1)(a) and (b) that a first order of the first bit and the second bit does not form a first combination of values, then act (C)(1)(c) further comprises an act of:
removing the first bit and the second bit from the first sequence to produce one of the second sequences.

73. The method of claim 65, wherein act (B) comprises:
for each of the one or more first sequences, determining that the first sequence is not a sequence of bits defined by the first block coding scheme.

74. The method of claim 65, wherein acts (A), (B) and (C) are performed by a network device that is part of an optical transport network, and the first stream of data is received from a network device external to the optical transport network.

75. The method of claim 74, wherein the signaling information is defined in accordance with the Optical Domain Service Interconnect.

76. The method of claim 65, wherein acts (A), (B) and (C) are performed by a network device external to an optical transport network, and the first stream is received from a network device that is part of the optical transport network.

77. The method of claim 76, wherein the signaling information is defined in accordance with the Optical Domain Service Interconnect.

78. The method of claim 65, wherein the signaling information is defined in accordance with the Optical Domain Service Interconnect.

79. A system for extracting signaling information from a first stream of data encoded in accordance with a first block coding scheme, wherein the signaling information has been encoded as one or more first sequences of bits and multiplexed with first data encoded in accordance with the first block coding scheme to produce the first stream of data, the system comprising:
an input to receive the first stream of data;
a demultiplexer to de-multiplex the one or more first sequences of bits from the first stream of data;
and a decoder to decode the one or more first sequences of bits into the signaling information.

80. The system of claim 79, wherein the system is operative to exchange data according to a first protocol, and the demultiplexer is operative to de-multiplex the one or more first sequences at the physical layer of the first protocol, and the decoder is operative to decode the one or more first sequences at the physical layer of the first protocol.

81. The system of claim 80, wherein the first protocol is an Ethernet-based protocol.

82. The system of claim 79, wherein, the signaling information had been decoded as one or more second sequences of bits, and the one or more second sequences has been encoded as the one or more first sequences, and
wherein the decoder is further operative to decode the one or more first sequences into the one or more second sequences.

83. The system of claim 82, wherein the first block coding scheme is an 8B/10B block coding scheme, the signaling information has been divided into one or more second sequences of eight bits, and each of the one or more second sequences of eight bits has been encoded such that each of the first sequences of bits has a number of bits equal to ten.

84. The system of claim 83, wherein the decoder is fuirther operative to determine a first value of a first bit at a first predefined position of the first sequence, to determine a second value of a second bit at a second predefined position of the first sequence, and to generate, from each first sequence of bits, at least part of one of the second sequences of bits based on the first value and the second value.

85. The system of claim 84, wherein, the decoder is further operative such that, for each first sequence of bits, if it is determined that a first order of the first bit and the second bit forms a first combination of values, then the decoder removes, from the first sequence, the first bit, the second bit, and four bits at four predefined positions of the first sequence, respectively, and combines the remaining four bits with four bits from another first sequence to produce one of the second sequences of bits.

86. The system of claim 84, wherein the decoder is further operative such that, for each first sequence of bits, if it is determined that a first order of the first bit and the second bit does not form a first combination of values, then the decoder removes the first bit and the second bit from the first sequence to produce one of the second sequences.

87. The system of claim 79, wherein the de-multiplexer is operative to determine, for each of the first sequences of bits, that the first sequence is not a sequence of bits defined by the first block coding scheme.

88. The system of claim 79, wherein the system is at least part of a network device of an optical transport network, and the first stream of data is received from a network device external to the optical transport network.

89. The system of claim 88, wherein the signaling information is defined in accordance with the Optical Domain Service Interconnect.

90. The system of claim 79, wherein the system is at least part of a network device external to an optical transport network second device and the first stream of data is received from a network device which is part of an optical transport network.

91. The system of claim 90, wherein the signaling information is defined in accordance with the Optical Domain Service Interconnect.

92. The system of claim 79, wherein the signaling information is defined in accordance with the Optical Domain Service Interconnect.

93. A system for extracting signaling information from a first stream of data encoded in accordance with a first block coding scheme, wherein the signaling information has been encoded as one or more first sequences of bits and multiplexed with first data encoded in accordance with the first block coding scheme to produce the first stream of data, the system comprising:
means for receiving the first stream of data;
means for de-multiplexing the one or more first sequences of bits from the first stream of data; and
means for decoding the one or more first sequences of bits into the signaling information.

94. The system of claim 93, wherein the system is operative to exchange data according to a first protocol, and the means for de-multiplexing comprises means for demultiplexing the one or more first sequences at a physical layer of the first protocol, and the means for decoding comprises means for decoding the one or more first sequences at the physical layer of the first protocol.

95. The system of claim 94, wherein the first protocol is an Ethernet-based protocol.

96. The system of claim 93, wherein the signaling information had been divided into one or more second sequences of bits, and the one or more second sequences of bits has been encoded as the one or more first sequences of bits, and wherein the means for decoding comprises:
means for decoding the one or more of the first sequences into the one or more second sequences.

97. The system of claim 96, wherein the first block coding scheme is an 8B/10B block coding scheme, the signaling information has been divided into one or more second sequences of eight bits, and each of the one or more second sequences of eight bits has been encoded such that each of the first sequences of bits has a number of bits equal to ten.

98. The system of claim 97, wherein the means for decoding comprises, for each first sequence of bits:
means for determining a first value of a first bit at a first predefined position of the first sequence;
means for determining a second value of a second bit at a second predefined position of the first sequence; and
means for generating, from each first sequence of bits, at least part of one of the second sequences of bits based on the first value and the second value.

99. The system of claim 98, wherein the means for decoding further comprises, for each first sequence of bits, if it is determined that a first order of the first bit and the second bit forms a first combination of values:
means for removing, from the first sequence, the first bit, the second bit, and four bits at four predefined positions of the first sequence, respectively; and
means for combining the remaining four bits with four bits from another first sequence to produce one of the second sequences of bits.

100. The system of claim 98, wherein the means for decoding further comprises, for each first sequence of bits, if it is determined that a first order of the first bit and the second bit does not form a first combination of values:
means for removing the first bit and the second bit from the first sequence to produce one of the second sequences.

101. The system of claim 93, wherein the means for de-multiplexing comprises:
means for determining, for each of the one or more first sequences, that the first sequence is not a sequence of bits defined by the first block coding scheme.

102. The system of claim 93, wherein the system is at least part of a network device that is part of an optical transport network, and the first stream of data is received from a network device external to the optical transport network.

103. The system of claim 102, wherein the signaling information is defined in accordance with the Optical Domain Service Interconnect.

104. The system of claim 93, wherein the system is at least part of a network device external to an optical transport network, and the first stream is received from a network device that is part of the optical transport network.

105. The system of claim 104, wherein the signaling information is defined in accordance with the Optical Domain Service Interconnect.

106. The system of claim 93, wherein the signaling information is defined in accordance with the Optical Domain Service Interconnect.

107. A computer program product, comprising:
a computer-readable medium; and
computer-readable signals stored on the computer-readable medium that define instructions that, as a result of being executed by a computer, instruct the computer to perform a process of extracting signaling information from a first stream of data encoded in accordance with a first block coding scheme, wherein the signaling information has been encoded as one or more first sequences of bits and multiplexed with first data encoded in accordance with the first block coding scheme to produce the first stream of data, the process comprising acts of:
(A) receiving the first stream of data;
(B) de-multiplexing the one or more first sequences of bits from the first stream of data; and
(C) decoding the one or more first sequences of bits into the signaling information.

108. A method of transmitting signaling information from a first device to a second device, wherein data transmitted between the first device and the second device is encoded using a first block coding scheme, the method comprising acts of:
(A) encoding the signaling information as one or more first sequences of bits;
(B) multiplexing the one or more first sequences of bits with first data encoded in accordance with the first block coding scheme to produce a first stream of data encoded in accordance with the first block coding scheme;
(C) transmitting the first stream of data from the first device to the second device;
(D) de-multiplexing the one or more first sequences of bits from the first stream of data; and
(E) decoding the one or more first sequences of bits into the signaling information.

109. A system for transmitting signaling information from a first device to a second device, wherein data transmitted between the first device and the second device is encoded using a first block coding scheme, the system comprising:
a first device comprising an encoder to encode the signaling information as one or more first sequences of bits, a multiplexer to multiplex the one or more first sequences of bits with first data encoded in accordance with the first block coding scheme to produce a first stream of data encoded in accordance with the first block coding scheme, and an output to transmit the first stream of data from the first device to the second device; and
a second device comprising an input to receive the first stream of data, a demultiplexer to de-multiplex the one or more first sequences of bits from the first stream of data and a decoder to decode the one or more first sequences of bits into the signaling information.

110. A system for transmitting signaling information from a first device to a second device, wherein data transmitted between the first device and the second device is encoded using a first block coding scheme, the system comprising:
means for encoding the signaling information as one or more first sequences of bits;
means for multiplexing the one or more first sequences of bits with first data encoded in accordance with the first block coding scheme to produce a first stream of data encoded in accordance with the first block coding scheme;
means for transmitting the first stream of data from the first device to the second device;
means for de-multiplexing the one or more first sequences of bits from the first stream of data; and
means for decoding the one or more first sequences of bits into the signaling information.

111. A computer program product, comprising:
a computer-readable medium; and
computer-readable signals stored on the computer-readable medium that define instructions that, as a result of being executed by a computer, instruct the computer to perform a process of transmitting signaling information from a first device to a second device, wherein data transmitted between the first device and the second device is encoded using a first block coding scheme, the process comprising acts of:
(A) encoding the signaling information as one or more first sequences of bits;
(B) multiplexing the one or more first sequences of bits with first data encoded in accordance with the first block coding scheme to produce a first stream of data encoded in accordance with the first block coding scheme;
(C) transmitting the first stream of data from the first device to the second device;
(D) de-multiplexing the one or more first sequences of bits from the first stream of data; and
(E) decoding the one or more first sequences of bits into the signaling information.
